(19) United States
(12) Patent Application Publication
(10) Pub. No.: US 2006/0058454 A1
(43) Pub. Date: Mar. 16, 2006

(54) Method for producing aqueous polyurethane dispersions in miniemulsion and in the presence of a catalyst

(75) Inventors: Ulrike Licht, Mannheim (DE); Susanne Deutrich, Munster (DE); Markus Antonietti, Bergholz-Rehbrucke (DE); Katharina Landfester, Berlin (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: MAX-PLANCK-GESELLSCHAFT, Muenchen (DE)

(21) Appl. No.: 10/544,763

(22) PCT Filed: Jan. 28, 2004
(86) PCT No.: PCT/EP04/00705

§ 371 Date: Aug. 8, 2005

(30) Foreign Application Priority Data
Feb. 28, 2003 (DE) 103 09 204.8

(51) Int. Cl. C08G 18/08

(52) U.S. Cl. 524/589

(57) ABSTRACT

A process for preparing aqueous primary dispersions comprising at least one hydrophobic polyurethane obtainable in miniemulsion by reacting (a) at least one polyisocyanate and (b) at least one compound containing at least one isocyanate-reactive group in the presence of a catalyst.

The present invention relates to a process for preparing aqueous polyurethane dispersions.

Aqueous polyurethane dispersions (also referred to for short as PU dispersions) and processes for preparing them are common knowledge. They are prepared by the acetone process or by the prepolymer mixing process. A disadvantage is that such processes are complicated and expensive, especially if solvents are used. Furthermore the reagents via which the hydrophilic groups are introduced are expensive specialty chemicals. PU dispersions have been used for a long time to coat substrates such as leather, textiles, wood, metal or plastic, for example.

Dispersions can also be prepared from miniemulsions. Miniemulsions are composed of water, an oil phase, and one or more surface-active substances and have a droplet size of from 5 to 50 nm (microemulsion) or from 50 to 500 nm. Miniemulsions are considered to be metastable (P. A. Lovell, M. El-Aasser, Emulsion Polymerization and Emulsion Polymers, John Wiley and Sons, Chichester, N.Y., Weinheim, 1997, pages 700 ff., M. El-Aasser, Advances in Emulsion Polymerization and Latex Technology, 30^{th} Annual Short Course, Vol. 3, Jun. 7-11, 1999, Emulsion Polymers Institute, Lehigh University, Bethlehem, Pa., USA).

The literature discloses numerous processes for preparing aqueous primary dispersions by free-radical miniemulsion polymerization of olefinically unsaturated monomers (examples are WO 98/02466, DE-A 196 28 143, DE-A 196 28 142, EP-A-401 565, WO 97/49739, EP-A 755 946, and DE-A 199 24 674) in which no description is given of the polyaddition of isocyanates with polyols to give polyurethane.

Dispersions comprising polyurethanes are described for example in German laid-open specification DE-A 198 25 453. WO 00/29465 discloses the uncatalyzed reaction of isocyanate and hydroxyl compounds in aqueous miniemulsions to give polyurethanes.

Also known are polyurethanes without hydrophilic groups, with or without solvents. The disadvantage of such polyurethanes in particular, owing to environmental problems, is their use of solvents or free isocyanate. Moreover, they have lower molar masses than the dispersions.

The use of organotin compounds such as dibutyltin dilaurate, for example, as catalysts for preparing PU dispersions is described in DE-A 199 59 653. DE-A 199 17 897 describes a process for producing polyurethane foams from specific polyetherols using metal salt catalysts, with potassium salts being used in particular. The earlier German patent application with the number 10161156.0 describes the polyaddition of diisocyanates and diols in the presence of a cesium salt. A disadvantage of these processes is that they are carried out via the intermediate step of preparing a prepolymer.

WO 02/064657 teaches the noncatalytic preparation of aqueous polyurethane dispersions without the intermediate step of preparing a prepolymer.

It is an object of the present invention to find a process for preparing polyurethane miniemulsions which does not have the disadvantages depicted and which leads to improved PU dispersions. A particular aim is to find a rapid reaction regime which leads to a selectivity increase and to higher molar masses of the polyurethanes.

We have found that this object is achieved by a process for preparing aqueous primary dispersions comprising at least one hydrophobic polyurethane obtainable in miniemulsion by reacting at least one polyisocyanate (a) and at least one compound (b) containing at least one isocyanate-reactive group, wherein at least one catalyst is added.

The PU dispersions prepared by the process of the invention are quick to synthesize and are inexpensive, on account of the fact in particular that there is no preliminary stage of preparing a prepolymer.

For the purposes of the present invention the property of being hydrophilic describes the constitutional property of a molecule or functional group to penetrate the aqueous phase or to remain therein. Correspondingly, a hydrophobic molecule or functional group is one with the constitutional property of behaving exophilically with respect to water, i.e., of not penetrating water or of departing the aqueous phase. For further details refer to Römpp Lexikon Lacke und Druckfarben, Georg Thieme Verlag, Stuttgart, N.Y., 1998, pages 294 and 295.

The process of the invention finds application in miniemulsion polymerization to give polyurethanes.

With these processes, generally speaking, in a first step a mixture is prepared from the monomers (a) and (b), the required amount of emulsifers and/or protective colloid, and also, if desired, hydrophobic addition and water, and an emulsion is produced from said mixture.

It has been found that the addition of catalysts promotes the urethanization. The addition of hydrophobic catalysts in particular promotes this process and also suppresses the unwanted side reaction with water to form urea.

In one preferred version of the process of the invention a mixture is first prepared from the monomers (a) and (b), emulsifiers and/or protective colloids, and, where appropriate, hydrophobic addition and water. Then an emulsion is produced and is heated with stirring. When the required reaction temperature has been reached the catalyst is added via the water phase. With particular preference a hydrophobic catalyst is added via the water phase. The water solubility of the hydrophobic catalyst is preferably ≦1 g/l.

The preferred addition of the preferably hydrophobic catalyst through the water phase following dispersion increases the selectivity and raises the molar mass.

Alternatively of course the catalyst can be added to the oil phase of the emulsion, i.e., to the monomer phase, before dispersion is carried out, or can be added to the water phase immediately after the emulsion is prepared. This is followed by heating with stirring.

Suitable catalysts include in principle all catalysts commonly used in polyurethane chemistry.

Examples of these catalysts include organic amines, especially tertiary aliphatic, cycloaliphatic or aromatic amines, and/or Lewis-acidic organometallic compounds. Examples of suitable Lewis-acidic organometallic compounds include tin compounds, such as tin(II) salts of organic carboxylic acids, e.g., tin(II) acetate, tin(II) octoate, tin(II) ethylhexoate, and tin(II) laurate, and the dialkyltin(IV) salts of organic carboxylic acids, e.g., dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate. Also possible are metal complexes such as acetylacetonates of iron, titanium, aluminum, zirconium, manganese, nickel, and cobalt. Other metal catalysts are described by Blank et al. in Progress in Organic Coatings, 1999, Vol. 35, pages 19-29.

Preferred Lewis-acidic organometallic compounds are dimethyltin diacetate, dibutyltin dibutyrate, dibutyltin bis(2-ethylhexanoate), dibutyltin dilaurate, dioctyltin dilaurate, zirconium acetylacetonate, and zirconium 2,2,6,6-tetramethyl-3,5-heptanedionate.

Bismuth and cobalt catalysts as well, and also cesium salts, can be used as hydrophobic catalysts. Suitable cesium salts include those compounds in which the following anions are used: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄²⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and (Cₙ₊₁H₂ₙ₋₂O₄)²⁻, where n is a number from 1 to 20.

Preference here is given to cesium carboxylates in which the anion obeys the formulae (CₙH₂ₙ₋₁O₂)⁻ and (Cₙ₊₁H₂ₙ₋₂O₄)²⁻ with n being from 1 to 20. Particularly preferred cesium salts have monocarboxylate anions of the formula (CₙH₂ₙ₋₁O₂)⁻ where n is a number from 1 to 20. Here, mention may be made in particular of formate, acetate, propionate, hexanoate, and 2-ethylhexanoate.

Examples of customary organic amines that may be mentioned include the following: triethylamine, 1,4-diazabicyclo[2.2.2]octane, tributylamine, dimethylbenzylamine, N,N,N′,N′-tetramethylethylenediamine, N,N,N′,N′-tetramethylbutanediamine, N,N,N′,N′-tetramethylhexane-1,6-diamine, dimethylcyclohexylamine, dimethyidodecylamine, pentamethyldipropylenetriamine, pentamethyldiethylenetriamine, 3-methyl-6-dimethylamino-3-azapentol, dimethylaminopropylamine, 1,3-bisdimethylaminobutane, bis-(2-dimethylaminoethyl) ether, N-ethylmorpholine, N-methylmorpholine, N-cyclohexylmorpholine, 2-dimethylaminoethoxyethanol, dimethylethanolamine, tetramethylhexamethylenediamine, dimethylamino-N-methylethanolamine, N-methylimidazole, N-formyl-N,N′-dimethylbutylenediamine, N-dimethylaminoethylmorpholine, 3,3′-bisdimethylamino-di-n-propylamine and/or 2,2′-dipiperazine diisopropyl ether, dimethylpiperazine, tris-(N,N-dimethylaminopropyl)-s-hexahydrotriazine, imidazoles such as 1,2-dimethylimidazole, 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole.

Preferred organic amines are trialkylamines having independently of one another two C₁- to C₄ alkyl radicals and one alkyl or cycloalkyl radical having 4 to 20 carbon atoms, examples being dimethyl-C₄-C₁₅-alkylamines such as dimethyldodecylamine or dimethyl-C₃-C₈-cycloalkylamine. Likewise preferred organic amines are bicyclic amines, with or without a further heteroatom such as oxygen or nitrogen, such as 1,4-diazabicyclo[2.2.2]octane, for example.

It will be appreciated that it is also possible to use mixtures of two or more of the aforementioned compounds as catalysts.

Particular preference is given to using hydrophobic catalysts from among the compounds mentioned.

The catalysts are used preferably in an amount of from 0.0001 to 10% by weight, more preferably in an amount of from 0.001 to 5% by weight, based on the total amount of the monomers used.

Depending on the nature of the catalyst it can be added in solid or liquid form and also in solution. Suitable solvents are water-immiscible solvents such as aromatic or aliphatic hydrocarbons and also carboxylic esters such as toluene, ethyl acetate, hexane, and cyclohexane, for example. The catalysts are preferably added in solid or liquid phase.

In one preferred embodiment of the invention the ratio of isocyanate groups (a) to isocyanate-reactive groups (b) is from 0.8:1 to 3:1, preferably from 0.9:1 to 1.5:1, more preferably 1:1.

In accordance with the invention the aqueous dispersions comprise polyurethanes prepared from polyisocyanates. Suitable polyisocyanates (a) include with preference the diisocyanates commonly used in polyurethane chemistry.

Particular mention may be made of diisocyanates X(NCO)₂ in which X is an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of diisocyanates of this kind include tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis-(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenyl-methane, p-xylylene diisocyanate, tetramethylxylylene diisocyanate (TMXDI), the isomers of bis-(4-isocyanatocyclohexyl)methane (HMDI) such as the trans/trans, the cis/cis, and the cis/trans isomer, and mixtures of these compounds.

Preference is given to using 1-isocyanato-3,5,5-trimethyl-5-isocyanatomethyl-cyclohexane (IPDI), tetramethylxylylene diisocyanate (TMXDI), hexamethylene diisocyanate (HDI), and bis-(4-isocyanatocyclohexyl)methane (HMDI).

Diisocyanates of this kind are available commercially.

As mixtures of these isocyanates particular importance attaches to the mixtures of the respective structural isomers of diisocyanatotoluene and of diisocyanatodiphenylmethane; the mixture of 80 mol % 2,4-diisocyanatotoluene and 20 mol % 2,6 diisocyanatotoluene is particularly suitable. Also advantageous are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in particular, with the preferred mixing ratio of the aliphatic to the aromatic isocyanates being from 4:1 to 1:4.

For synthesizing the polyurethanes it is possible to use as compounds (a) apart from the abovementioned isocyanates, those isocyanates which in addition to the free isocyanate groups carry further, blocked isocyanate groups, e.g., isocyanurate, biuret, urea, allophanate, uretdione or carbodiimide groups.

Examples of suitable isocyanate-reactive groups are hydroxyl, thiol, and primary and secondary amino groups. Preference is given to using hydroxyl-containing compounds or monomers as isocyanate-reactive compounds or monomers (b). Alongside these it is also possible to use amino-containing compounds as monomers (b3).

As compounds or monomers (b) it is preferred to use diols.

With a view to good film forming and elasticity suitable compounds (b) containing isocyanate-reactive groups include primarily diols (b1) of relatively high molecular mass, having a molecular weight of from about 500 to 5000 g/mol, preferably from about 1000 to 3000 g/mol.

The diols (b1) are, in particular, polyesterpolyols, which are known for example from Ullmanns Encyklopädie der Technischen Chemie, 4th edition, volume 19, pages 62 to 65. Preference is given to using polyesterpolyols obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cycloaliphatic, araliphatic, aromatic or heterocyclic and may have been substituted, by halogen atoms for example, and/or may be unsaturated. Examples thereof that may be mentioned include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid, and dimeric fatty acids. Preferred dicarboxylic acids are those of the formula HOOC—(CH₂)_{y}—COOH, where y is a number from 1 to 20, preferably an even number from 2 to 20, examples being succinic acid, adipic acid, sebacic acid, and dodecanedicarboxylic acid.

Examples of suitable diols include ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexanes such as 1,4-bis(hydroxymethyl)-cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. Preferred alcohols are of the formula HO—(CH₂)ₓ—OH where x is a number from 1 to 20, preferably an even number from 2 to 20. Examples of such alcohols include ethylene glycol, butane-1,4-diol, hexane-1,6-diol, octane-1,8-diol, and dodecane-1,12-diol. Preference extends to neopentyl glycol and pentane-1,5-diol. These diols can also be used as diols (b2) directly to synthesize the polyurethanes.

Also suitable, furthermore, are polycarbonate diols (b1), such as may be obtained, for example, by reacting phosgene with an excess of the low molecular mass alcohols specified as synthesis components for the polyester polyols.

Also suitable are lactone-based polyesterdiols (b1), which are homopolymers or copolymers of lactones, preferably hydroxy-terminated adducts of lactones with suitable difunctional starter molecules. Suitable lactones include preferably those derived from compounds of the formula HO—(CH₂)_{z}—COOH where z in a number from to 1 to 20 and where one hydrogen atom of a methylene unit may also have been substituted by a C₁ to C₄-alkyl radical. Examples are ε-caprolactone, β-propiolactone, γ-butyrolactone and/or methyl-ε-caprolactone, and also mixtures thereof. Examples of suitable starter components are the low molecular mass dihydric alcohols specified above as a synthesis component for the polyester polyols. The corresponding polymers of ε-caprolactone are particularly preferred. Lower polyesterdiols or polyetherdiols as well can be used as starters for preparing the lactone polymers. Instead of the polymers of lactones it is also possible to use the corresponding, chemically equivalent polycondensates of the hydroxycarboxylic acids corresponding to the lactones.

Further suitable monomers (b1) include polyetherdiols. These are obtainable in particular by polymerizing ethylene oxide, propylene oxide, butylene oxide, tetrahydrofuran, styrene oxide or epichlorohydrin with itself, in the presence of BF₃ for example, or by subjecting these compounds, alone or in a mixture or in succession, to addition reactions with starting components containing reactive hydrogen atoms, such as alcohols or amines, e.g., water, ethylene glycol, propane-1,2-diol, propane-1,3-diol, 1,1-bis-(4-hydroxyphenyl)propane or aniline. Particular preference is given to polytetrahydrofuran with a molecular weight of from 240 to 5000 g/mol, and in particular from 500 to 4500 g/mol. In addition it is also possible to use mixtures of polyesterdiols and polyetherdiols as monomers (b1).

Likewise suitable are polyhydroxyolefins (b1), preferably those having 2 terminal hydroxyl groups, e.g., α,ω-dihydroxypolybutadiene, α,ω-dihydroxypolymethacrylic esters or α,ω-dihydroxypolyacrylic esters, as monomers (b1). Such compounds are known for example from EP-A 622 378. Further suitable polyols (b1) are polyacetals, polysiloxanes, and alkyd resins.

The hardness and the elasticity modulus of the polyurethanes can be increased by using as diols (b) not only the relatively high molecular mass diols (b1) but also low molecular mass diols (b2), having a molecular weight of from about 60 to 500 g/mol, preferably from 62 to 200 g/mol.

Diols (b2) used include in particular the synthesis components with the short-chain alkane diols specified for the preparation of polyester polyols, with preference being given to the unbranched diols having from 2 to 12 carbon atoms and an even number of carbon atoms, and also to pentane-1,5-diol and neopentyl glycol. Phenols or bisphenol A or F are additionally suitable as diols (b2).

The fraction of the diols (b1), based on the total amount of diols (b), is preferably from 0 to 100 mol %, in particular from 10 to 100 mol %, more preferably from 20 to 100 mol %, and the fraction of the monomers (b2), based on the total amount of diols (b), is preferably from 0 to 100 mol %, in particular from 0 to 90 mol %, more preferably from 0 to 80 mol %. With particular preference the ratio of the diols (b1) to the monomers (b2) is from 1:0 to 0:1, preferably from 1:0 to 1:10, and more preferably from 1:0 to 1:5.

For components (a) and (b) it is also possible to employ functionalities >2.

Examples of suitable monomers (b3) are hydrazine, hydrazine hydrate, ethylenediamine, propylenediamine, diethylenetriamine, dipropylenetriamine, isophoronediamine, 1,4-cyclohexyldiamine, N-(2-aminoethyl)ethanolamine, and piperazine.

In minor amounts it is also possible to use monofunctional hydroxyl-containing and/or amino-containing monomers (b3). Their fraction should not exceed 10 mol %, based on components (a) and (b).

In accordance with the invention the diameters of the monomer droplets in the emulsion thus prepared are normally <1000 nm, frequently <500 nm. In the normal case the diameter is >40 nm. Preference is given accordingly to values of between 40 and 1000 nm. 50-500 nm are particularly preferred. Especial preference is given to the range from 100 nm to 300 nm and the utmost preference to the range from 200 to 300 nm.

The emulsion is prepared in conventional manner. The average size of the droplets of the dispersed phase of the aqueous emulsion can be determined in accordance with the principle of quasielastic light scattering (the z-average droplet diameter dz of the unimodal analysis of the autocorrelation function). This can be done using, for example, a Coulter N3 Plus Particle Analyser from Coulter Scientific Instruments.

The emulsion can be prepared using high-pressure homogenizers for example. In these machines the fine division of the components is achieved by means of a high local energy input. Two versions have proven particularly appropriate in this respect:

In the first version the aqueous macroemulsion is compressed to more than 1000 bar by means of a piston pump, for example, and is then released through a narrow slot. The effect here is based on an interplay of high shear gradients and pressure gradients and cavitation in the slot. One example of a high-pressure homogenizer which operates in accordance with this principle is the Niro-Soavi high-pressure homogenizer type NS1001L Panda.

In the case of the second version the compressed aqueous macroemulsion is released into a mixing chamber through two nozzles directed against one another. In this case the fine distribution effect is dependent in particular on the hydrodynamic conditions prevailing within the mixing chamber. One example of this type of homogenizer is the Microfluidizer type M 120 E from Microfluidics Corp. In this high-pressure homogenizer the aqueous macroemulsion is compressed to pressures of up to 1200 bar by a pneumatically operated piston pump and is released via what is called an “interaction chamber”. Within the “interaction chamber” the emulsion jet is divided, in a microchannnel system, into two jets which are collided at an angle of 180°. Another example of a homogenizer which operates in accordance with this type of homogenization is the Nanojet Type Expo from Nanojet Engineering GmbH. In the Nanojet, however, instead of a fixed channel system, two homogenizing valves are installed which can be adjusted mechanically.

As an alternative to the principles set out above, homogenization may also be effected, for example, using ultrasound (e.g., Branson Sonifier II 450). The fine distribution here is based on cavitation mechanisms. For homogenization by means of ultrasound the devices described in GB-A 22 50 930 and in U.S. Pat. No. 5,108,654 are also suitable in principle. The quality of the aqueous emulsion E1 produced in the sonic field depends in this case not only on the sonic input but also on other factors, such as the intensity distribution of the ultrasound in the mixing chamber, the residence time, the temperature, and the physical properties of the substances to be emulsified—for example, the viscosity, surface tension, and vapor pressure. The resulting droplet size depends, inter alia, on the concentration of the emulsifier and on the energy introduced during homogenization, and can therefore be adjusted selectively by, for example, altering the homogenization pressure and/or the corresponding ultrasound energy accordingly.

For the preparation of the emulsion of the invention from conventional emulsions by means of ultrasound, the device which has proven particularly suitable is that described in DE-A 197 56 874, which is expressly included herein by reference.

With particular advantage the means for transferring ultrasound waves is designed as a sonotrode whose end remote from the free emitting area is coupled to an ultrasound transducer. The ultrasound waves may be produced, for example, by exploiting the inverse piezoelectric effect. In this case generators are used to generate high-frequency electrical oscillations (usually in the range from 10 to 100 kHz, preferably between 20 and 40 kHz), and these are converted by a piezoelectric transducer into mechanical vibrations of the same frequency, and, with the sonotrode as transfer element, are coupled into the medium that is to be sonicated.

The emulsion can also be prepared by spraying through a nozzle. In this case the emulsion is prepared continuously at the rate at which it is consumed, by the mixing of its components using a mixer apparatus which has at least one nozzle, selected from solid cone nozzle, hollow cone nozzle, flat jet nozzle, smooth jet nozzle, injector nozzle, ejector nozzle, spiral nozzle, impact jet nozzle, two-fluid nozzle or emulsifying baffle (WO 02/085955).

It is appropriate to prepare the emulsion with sufficient rapidity that the emulsifying time is small in comparison to the reaction time of the monomers with one another and with water.

One preferred embodiment of the process of the invention involves preparing all of the emulsion with cooling to temperatures <RT. The emulsion is preferably prepared within less than 10 minutes. The catalyst is then added and the desired reaction temperature is established. The reaction temperatures are between RT and 120° C., preferably between 50 and 100° C. In another preferred embodiment the hydrophobic catalyst is added through the water phase only after the reaction temperature has been reached.

In another version of the process of the invention first of all the emulsion is prepared from the monomers (a) and (b1) and/or (b2), emulsifiers and/or protective colloids, and also, where appropriate, hydrophobic addition and water, before, once again, the hydrophobic catalyst is added and the monomers (b3) are added dropwise after the theoretical NCO content has been reached.

Generally when producing miniemulsions use is made of ionic and/or nonionic emulsifiers and/or protective colloids and/or stabilizers as surface-active compounds.

A detailed description of suitable protective colloids can be found in Houben-Weyl, Methoden der Organischen Chemie, volume XIV/1, Makromolekulare Stoffe [Macromolecular compounds], Georg Thieme Verlag, Stuttgart, 1961, pp. 411 to 420. Suitable emulsifiers include anionic, cationic, and nonionic emulsifiers. As concomitant surface-active substances it is preferred to use exclusively emulsifiers, whose molecular weights, unlike those of the protective colloids, are usually below 2000 g/mol. Where mixtures of surface-active substances are used it is of course necessary that the individual components are compatible with one another, something which in case of doubt can be checked by means of a few preliminary tests. Anionic and nonionic emulsifiers are preferably used as surface-active substances. Customary accompanying emulsifiers are, for example, ethoxylated fatty alcohols (EO units: 3 to 50, alkyl: C₈ to C₃₆), ethoxylated mono-, di-, and tri-alkylphenols (EO units: 3 to 50, alkyl: C₄ to C₉), alkali metal salts of dialkyl esters of sulfosuccinic acid, and also alkali metal salts and/or ammonium salts of alkyl sulfates (alkyl: C₈ to C₁₂), of ethoxylated alkanols (EO units: 4 to 30, C₉), of alkylsulfonic acids (alkyl: C₁₂ to C₁₈), and of alkylarylsulfonic acids (alkyl: C₉ to C₁₈).

Suitable emulsifiers can also be found in Houben-Weyl, Methoden der Organischen Chemie, volume 14/1, Makromolekulare Stoffe, Georg Thieme Verlag, Stuttgart, 1961, pages 192 to 208.

Examples of emulsifier trade names include Dowfax® 2 A1, Emulan® NP 50, Dextrol® OC 50, Lumiten® N-OP 25, Emulphor® OPS 25, Emulan® OG, Texapon® NSO, Nekanil® 904 S, Lumiten® 1-RA, Lumiten® E 3065, Steinapol NLS, etc.

The amount of emulsifier for preparing the aqueous emulsion is appropriately chosen in accordance with the invention so that in the aqueous emulsion which ultimately results, within the aqueous phase, the critical micelle concentration of the emulsifiers used is essentially not exceeded. Based on the amount of monomers present in the aqueous emulsion this amount of emulsifier is generally in the range from 0.1 to 5% by weight. As already mentioned, protective colloids can be added to the emulsifiers and have the capacity to stabilize the disperse distribution of the aqueous polymer dispersion which ultimately results. Irrespective of the amount of emulsifier used the protective colloids can be employed in amounts of up to 50% by weight, for example, in amounts of from 1 to 30% by weight based on the monomers.

As costabilizers it is possible to add to the monomers substances which have solubility in water of <5×10⁻⁵ g/l, preferably 5×10⁻⁷ g/l, in amounts of from 0.01 to 10% by weight. Examples are hydrocarbons such as hexadecane, halogenated hydrocarbons, silanes, siloxanes, hydrophobic oils (olive oil), dyes, etc. In their stead it is also possible for blocked polyisocyanates to take on the function of the hydrophobe.

The dispersions of the invention are used for preparing coating materials, adhesives, and sealants. They can also be used for producing films or sheets, and also for impregnating, say, textiles.

In the context of their use as coating materials the PU dispersions of the invention combine excellent hardness with excellent elasticity. On flexible substrates toughness and extensibility are ensured. It is additionally possible to produce materials which achieve excellent thermal stabilities. In the context of use in adhesives the high bond strength is a further factor.

The examples below are intended to illustrate the invention, though without restricting it.

The average particle size is determined by quasielastic light scattering in accordance with ISO 13321 using a Nicomp particle sizer, model 370, on samples at a concentration of 0.01% by weight. The polydispersity Mw/Mn, the ratio of the weight-average to the number-average molecular weight, is a measure of the molecular weight distribution of the polymers and ideally has the value 1. The figures given for the polydispersity and also for the number-average and weight-average molecular weight Mn and Mw relate here to measurements made by gel permeation chromatography using polystyrene as standard and tetrahydrofuran as eluent. The method is described in Analytiker Taschenbuch vol. 4, pages 433 to 442, Berlin 1984.

### EXAMPLE 1

3.141 g of 1-isocyanato-3,5,5-trimethyl-5-isocyanatomethylcyclohexane (IPDI), 2.859 g of pulverized dodecane-1,12-diol, 200 mg of hexadecane, 200 mg of sodium dodecyl sulfate and 24 g of water were stirred together at room temperature for 1 hour. The miniemulsion was produced by sonicating with a Branson Sonifier® W-450 (120 s with 90% amplitude in an ice bath). The reaction temperature was then raised to 60° C. and a catalyst was added. The reaction was ended after 4 hours. The results are summarized in Table 1.

TABLE 1

| | | | Particle | | Poly- |
|---|---|---|---|---|---|
| | | Amount of | size | | dispersity |
| No. | Catalyst | catalyst [mg] | [nm] | M_{w} × 10³ | index |
| 1 | — | — | 175 | 3.75 | 1.8 |
| 2 | DMDA | 25 | 175 | 3.71 | 1.8 |
| 3 | DMTDA | 25 | 165 | 4.05 | 1.8 |
| 4 | DBTDB | 25 | 175 | 3.81 | 1.8 |
| 5 | DBTDH | 25 | 165 | 9.05 | 2.1 |
| 6 | DBTL | 25 | 170 | 7.28 | 2.1 |
| 7 | DOTDL | 25* | 170 | 8.24 | 2.1 |
| 8 | DMDA/DBTDL | 25/25 | 160 | 7.19 | 2.2 |

*added prior to emulsification
DMDA: dimethyldodecylamine
DMTDA: dimethyltin diacetate
DBTDB: dibutyltin dibutyrate
DBTDH: dibutyltin bis(2-ethylhexanoate)
DBTL: dibutyltin dilaurate
DOTDL: dioctyltin dilaurate

### EXAMPLE 2

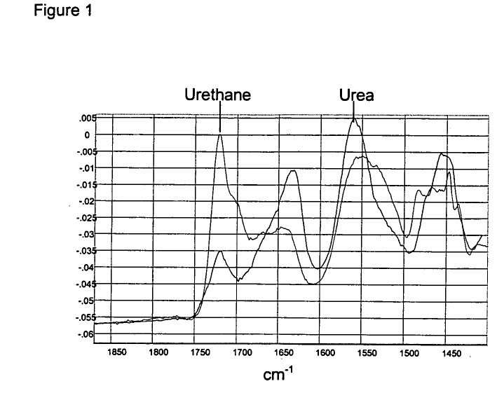

18 g of Poly® THF 1000 (BASF Aktiengesellschaft), 0.5 g of hexadecane and 4 g 1-isocyanato-3,5,5-trimethyl-5-isocyanatomethylcyclohexane were mixed at room temperature and blended with 50 g of fully deionized water to which 6 g of Steinapol NLS® (Goldschmidt AG) had been added. The mixture was sonicated with a Branson Sonifier® W-450 for 90 s at 100% amplitude and 50% pulse in an ice bath. Thereafter it was heated to 70° C. and stirred at this temperature for 2 h. An IR spectrum of the product was recorded, the result being shown in FIG. 1 (graph: “urea”).

Increased formation of urea is apparent as compared with the catalyzed reaction regime (Example 3).

### EXAMPLE 3

The experiment from Example 2 was repeated. When the temperature of 70° C. was reached two drops of DBTL were added and the mixture was stirred for 65 minutes.

An IR spectrum of the product was recorded, the result being shown in FIG. 1 (graph: “urethane”).

Increased formation of polyurethane is apparent as compared with the uncatalyzed reaction regime (Example 2).

1. A process for preparing an aqueous primary dispersion comprising at least one hydrophobic polyurethane obtained in at least one miniemulsion comprising reacting
(a) at least one polyisocyanate and
(b) at least one compound comprising at least one isocyanate-reactive group
in the presence of at least one catalyst to prepare the aqueous primary dispersion.

2. The process as claimed in claim 1, wherein
(1) a mixture of the monomers (a) and (b), at least one emulsifier and optionally, at least one protective colloid, and water is prepared,
(2) an emulsion is produced,
(3) the emulsion is heated with stirring, and
(4) the catalyst is added via the water phase
to produce the aqueous primary dispersion.

3. The process as claimed in claim 1, wherein the at least one catalyst is selected from the group consisting of the classes of the organic amines, Lewis-acidic organometallic compounds, and metal salts, or mixtures thereof.

4. The process of claim 1, wherein secondary or tertiary aliphatic, cycloaliphatic or aromatic amines are used as the at least one catalyst.

5. The process of claim 1, wherein tin(II) or tin(IV) salts of organic carboxylic acids are used as the at least one catalyst.

6. The process of claim 1, wherein cesium carboxylates are used as the at least one catalyst.

7. The process of claim 1, wherein dimethyldodecylamine, dimethyltin diacetate, dibutyltin dibutyrate, dibutyltin bis(2-ethylhexanoate), dibutyltin dilaurate, dioctyltin dilaurate, zirconium acetylacetonate, zirconium 2,2,6,6-tetramethyl-3,5-heptanedionate and optionally, cesium carboxylates are used as the at least one catalyst.

8. The process of claim 1, wherein a hydrophobic catalyst is used as the at least one catalyst.

9. The process of claim 1, wherein from 0.001 to 5% by weight of catalyst is used, based on the total amount of the monomers used.

10. The process of claim 1, wherein the ratio of component (a) to component (b) is 1:1.

11. The process of claim 1, wherein component (a) further comprises diisocyanates.

12. The process as claimed in claim 1, wherein 1-isocyanato-3,5,5-trimethyl-5-isocyanatomethylcyclohexane (IPDI), tetramethylxylylene diisocyanate (TMXDI), hexamethylene diisocyanate (HDI), and bis-(4-isocyanatocyclohexyl)methane (HMDI) are used as the at least one polyisocyanate.

13. The process as claimed in claim 1, wherein component (b) further comprises diols.

14. The process as claimed in claim 13, wherein, based on the total amount of the diols (b), from 20 to 100 mol % of the diols (b1) having a molecular weight of from 60 to 500 g/mol and from 0 to 80 mol % of the diols (b2) having a molecular weight of from 500 to 5000 g/mol are used.

15. The process as claimed in claim 1, wherein component (b) further comprises at least one compound comprising an amine (b3).

16. The process as claimed in claim 15, wherein, based on components (a) and (b), from 0 to 10 mol % of the at least one compound comprising an amine (b3) are used.

17. The process as claimed in claim 1, wherein the at least one miniemulsion has a monomer droplet size of from 50 to 500 nm.

18. The process as claimed in claim 1, wherein the at least one miniemulsion has a monomer droplet size of from 100 to 300 nm.

19. An aqueous primary dispersion prepared by the process of claim 1.

20. (canceled)

21. The process as claimed in claim 1, wherein
(1) a mixture of the monomers (a) and (b), at least one emulsifier and optionally, at least one protective colloid, and water is prepared,
(2) an emulsion is produced,
(3) the catalyst is added via the water phase, and
(4) the emulsion is heated with stirring
to produce the aqueous primary dispersion.
